(19) United States
(12) Patent Application Publication
(10) Pub. No.: US 2004/0150220 A1
(43) Pub. Date: Aug. 5, 2004

(54) Security articles

(76) Inventors: Brian William Holmes, Hampshire (GB); Paul Gregory Harris, Middlesex (GB); Malik Alibegovic, Winchester (GB); Mark Deakes, Berkshire (GB); James Leslie Board, Herts (GB)

Correspondence Address: Oliff & Berridge, P O Box 19928, Alexandria, VA, 22320, US

(21) Appl. No.: 10/476,609

(22) PCT Filed: May 8, 2002
(86) PCT No.: PCT/GB02/02105

(30) Foreign Application Priority Data
May 11, 2001 (GB) 0111591.4
Dec. 17, 2001 (GB) 0130120.9

(51) Int. Cl. B42D 15/00

(52) U.S. Cl. 283/110

(57) ABSTRACT

A security article includes a security device comprising an opaque scratch removable layer (7) on and/or in which is provided a diffractive, optically variable effect generating structure (4). The scratch removable layer (7) overlies covert information (12) on the article. The security device exhibits first indicia which relate to second indicia elsewhere on the article.

The invention relates to security articles including an opaque scratch removable layer overlying covert information.

Scratch off pads are widely used, for example in lottery tickets, gaming cards, telephone credit top-up cards, to protect secure information from view until the item is purchased by the final owner and the opaque layer of material is removed. For example, U.S. Pat. No. 5,074,566, WO 9965578, WO 9501821, EP 0972548, GB 2185215, GB 2361894, GB 2085308 and GB 2075918 disclose the use of this type of device for game cards and lottery tickets.

To be functional the device must be completely opaque, so that the information cannot be read, even using intense light or other radiation, in either transmission or reflection.

The product must be sufficiently robust that it is not significantly damaged in normal handling, but must be easy to remove using, for example, the edge of a coin or a fingernail. Ideally, the material that is scraped off should not form a fine powder that stains the surrounding areas, but should agglomerate into coarse particulates. It must also not stain the substrate, so that once removed the secure data can be read without hindrance.

Products that fulfil these requirements have been disclosed, for example in U.S. Pat. No. 5,215,576 and DE 3614653, and are commercially available.

Unfortunately, the ready availability of such materials means that counterfeiters can acquire them and either counterfeit the entire device, or obtain genuine devices, read the secure data and replace the scratch off layer before reselling them.

An approach that has been used recently is to deposit a diffractive optically variable image device (DOVID), such as a hologram, computer generated diffractive structures or interference structures (in future for brevity these will simply be referred to as “holograms”), on the surface of the scratch off layer. Such devices are well known to be very hard to counterfeit. Holographic scratch cards are therefore intrinsically significantly more secure than their simpler counterparts, but already counterfeits are being detected. Examples are disclosed in U.S. Pat. No. 5,037,101 in which a hologram is provided underneath a scratch off layer and in U.S. Pat. No. 5,981,040 in which a hologram is provided on top of a scratch off layer.

There are various types of DOVIDs that range from quite simple to extremely complex, and so the first line of defence against counterfeits is to use a more sophisticated DOVID that is more difficult to copy. This makes the production of perfect copies (type 1 counterfeits) very difficult indeed. Unfortunately, it does not prevent counterfeiters who simply use a generic hologram and rely on the customer not knowing what should be there and hence realising that the device is a counterfeit (type 2 counterfeits).

There is thus a need to increase the security of such articles still further.

In accordance with a first aspect of the present invention, a security article includes a security device comprising an opaque scratch removable layer on and/or in which is provided a diffractive, optically variable effect generating structure, the scratch removable layer overlying covert information on the article, and wherein the security device exhibits first indicia which relate to second indicia elsewhere on the article.

With this invention, we overcome the problems mentioned above by providing a link between the first indicia exhibited by the security device and second indicia provided elsewhere on the article. It is easy for someone to check whether the first and second indicia are satisfactory and thus authenticate the device and article. For example, the first and second indicia could be the same or could be related or complement each other in an obvious way. Examples might be the company name/logo or a graphical design that is present both on the OVE structure and the printed areas of the article. The first and second indicia could also be designed so that when they are put together they combine so as to complete an overall design or image. Mirror images or the same image in different colours could be used.

In one approach, the first and second indicia cooperate together to define composite indicia which extend onto an adjacent part of the article. Thus, the first and second indicia could form different parts of a word which extends across the edge of the security device. Alternatively, the first and second indicia could be formed from different portions of the same graphical design or character. This could be implemented by a single optical variable effect generating structure extending from the security device onto the article, the structure being optionally transparent in the region overlying the article. Alternatively, indicia could be printed on the device and adjacent part of the article.

In other examples, the first indicia are separate from the second indicia.

Typically, the optically variable effect generating structure comprises a transparent layer defining a surface relief microstructure and a reflection enhancing layer on the surface relief. However, other types of optically variable effect generating structures such as volume holograms could also be utilized.

The first indicia may be incorporated using a number of techniques or even combinations of these techniques. They may be included within the imagery generated by the OVE structure, printed on top of the optically variable structure or formed by a patterned metallisation layer using the demetallisation process as described, for example, by U.S. Pat. No. 5,044,707 and U.S. Pat. No. 5,142,383.

An advantage of constructing the optically variable effect image generating structure from transparent and reflection enhancing layers is that the first indicia may be provided between the transparent and reflection enhancing layers. This is described in more detail in WO-A-91/06925 and leads to a very secure way of providing the indicia which is very difficult to counterfeit.

A powerful method of preventing counterfeiters from using the device and then replacing the OVE structure with a generic one is to arrange that the OVE structure not only covers the scratchable area but also overlaps onto the surrounding non-scratchable areas, because the optically variable effect generating structure does not scratch off from the surrounding areas and therefore provides a direct comparison to the structure provided by the security devices.

Conveniently, in this case, when the optically variable effect generating structure is formed by a transparent layer and a reflection enhancing layer, the reflection enhancing layer is partially transparent in the region overlying the non-scratchable areas allowing indicia under the partially transparent region to be visible. Indeed, the partially transparent region could overlie the whole of the article other than the region of the opaque scratch removable layer.

This aspect also forms a second aspect of the invention in which a security article including a security device comprises an opaque scratch removable layer on and/or in which is provided a diffractive, optically variable effect generating structure, the scratch removable layer overlying covert information on the article, and wherein the optically variable effect generating structure extends onto an adjacent part of the article beyond the scratch removable layer.

Where a reflection enhancing layer is provided, this could comprise a high refractive index coating such as zinc sulphide, titanium dioxide, tin oxide etc. or a metallic layer which may be continuous or discontinuous e.g. partially demetallised.

In a further example, the first indicia are provided over the optically variable effect generating structure, for example by printing.

In yet another example, where a partially metallised reflection enhancing layer is located over the non-scratchable areas, the first indicia could be defined by the partial metallisation.

In addition, where a partial metallisation is provided, the non-metallised regions could be filled with another, coloured metal to provide a contrast.

In accordance with a third aspect of the present invention, a security article including a security device comprising an opaque scratch removable layer on and/or in which is provided a diffractive, optically variable effect generating structure, the scratch removable layer overlying covert information on the article, and wherein the security device exhibits non-optically variable indicia within it.

Instead of printing, the optically variable effect generating structure itself may generate the first indicia as an optically variable image.

Where the first and/or second indicia are provided by printing, this may comprise any one of flexography, offset-litho, gravure, intaglio, and deskjet printing.

As a result of the protection provided by the opaque layer, such as a metallisation, it is not necessary to use highly coloured or metallic pigments in the scratch off layer.

It is, for example, possible to use white pigments such as titanium dioxide, or other materials such as mica, aluminium trihydrate, zinc sulphide or barium sulphate. The latter material is the preferred embodiment because it provides improved opacity to X-ray examination.

The use of such pigments has a number of advantages. They are normally cheaper than metallic pigments. Depending on the material chosen they can be easier to handle from a health and safety point of view. Most importantly, when directly applied devices are used on rough substrates the retained pigment is white, and this does not interfere with the appearance and reading of the device to an unacceptable level. Hence the more secure directly applied devices can be used on a range of substrates for which they would hitherto have been unsuitable.

The ability to use alternate materials in the devices brings with it other advantages. For example, the introduction of colours into the ink adds a level of customisation that the counterfeiter must try to match. Analysis of the precise composition of the fillers by, for example, X-ray fluorescence, provides a non-destructive forensic technique for checking the authenticity of the device. The inclusion of specialised pigments/dyes such as fluorescent, thermochromic or photochromic can also provide a useful authenticity check.

To facilitate viewing of the specialised pigments incorporated into the scratch removable layer a partially transparent optically variable device may be used, as described above.

In another preferred approach, the security device has an irregular shape, for example scalloped edges. This makes it more difficult to copy the device, and is particularly effective if integrated with print/artwork on the article so that any deviation from the shape is readily noticeable.

Thus, in accordance with a fourth aspect of the present invention, a security device comprises an opaque scratch removable layer having an irregular shape, such as scalloped edges.

The optically variable effect generating structure may comprise a diffraction grating or hologram.

It should also be noted that the security device may be provided removably on a carrier to enable it to be transferred to an article or alternatively could be formed directly on an article.

In accordance with a fifth aspect of the present invention, a security device comprises an opaque scratch removable layer on and/or in which is provided a diffractive, optically variable effect generating structure, the scratch removable layer overlying covert information on the article in use, and a transparent overlaminate secured to the scratch off layer over the optically variable effect generating structure, the overlaminate having a partially removable section to allow the underlying portion of the scratch off layer to be removed but being permanently adhered elsewhere to the scratch off layer.

In this aspect of the invention, part of the scratch removable layer can be accessed relatively easily following removal of the section of the overlaminate but since the overlaminate cannot be removed from other parts of the scratch removable layer, the layer cannot be scratched off in those regions and remains attached. Consequently, part of the optically variable effect generating structure will remain following the scratch off process and it is very difficult indeed for a counterfeiter to replace the scratched off material and the part of the optically variable effect generating structure which has been removed.

The partially removable section of the overlaminate may be formed as a separate entity from the remainder of the overlaminate but conveniently is die cut.

In order to assist removal, a tab may be provided connected to the partially removable section.

In accordance with a sixth aspect of the invention, a security device comprises an opaque scratch removable layer on and/or in which is provided a diffractive, optically variable effect generating structure; and a frangible layer carrying covert information, the frangible layer being secured directly or indirectly to the scratch removable layer.

The invention can be used in a wide variety of applications but is particularly suited for use on game cards or documents, lottery tickets, travel tickets, multiple use tickets (where for example, the scratch-off portion identifies the number, duration or commencement of use) telephone cards, personnel identification number or password notification documents, or as authentication devices on products or product packaging and the like so as to hide secure data on those articles.

Some examples of scratch-off pads and articles according to the invention will now be described and contrasted with known examples with reference to the accompanying drawings, in which:—

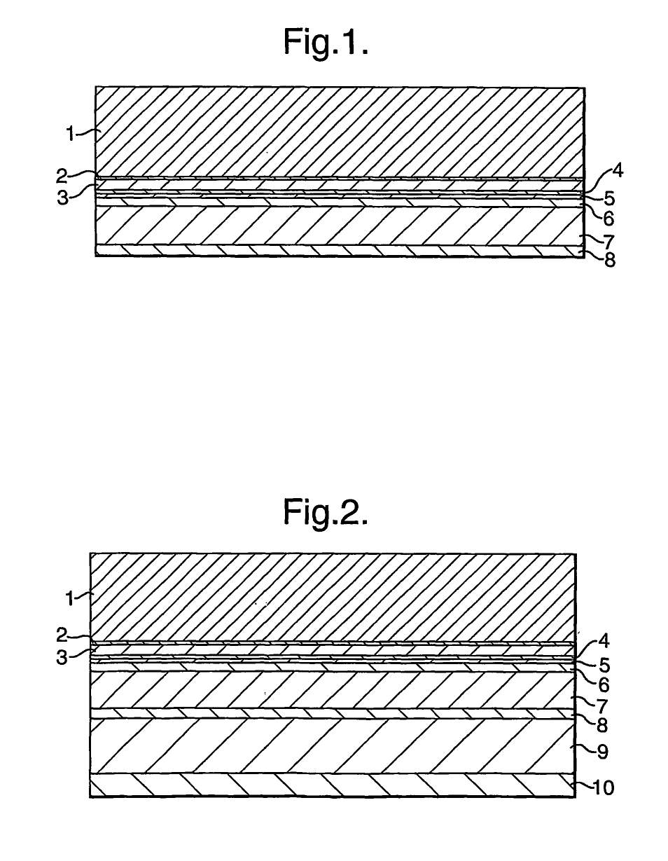

FIGS. 1 and 2 are schematic cross-sections through examples of known scratch-off pads;

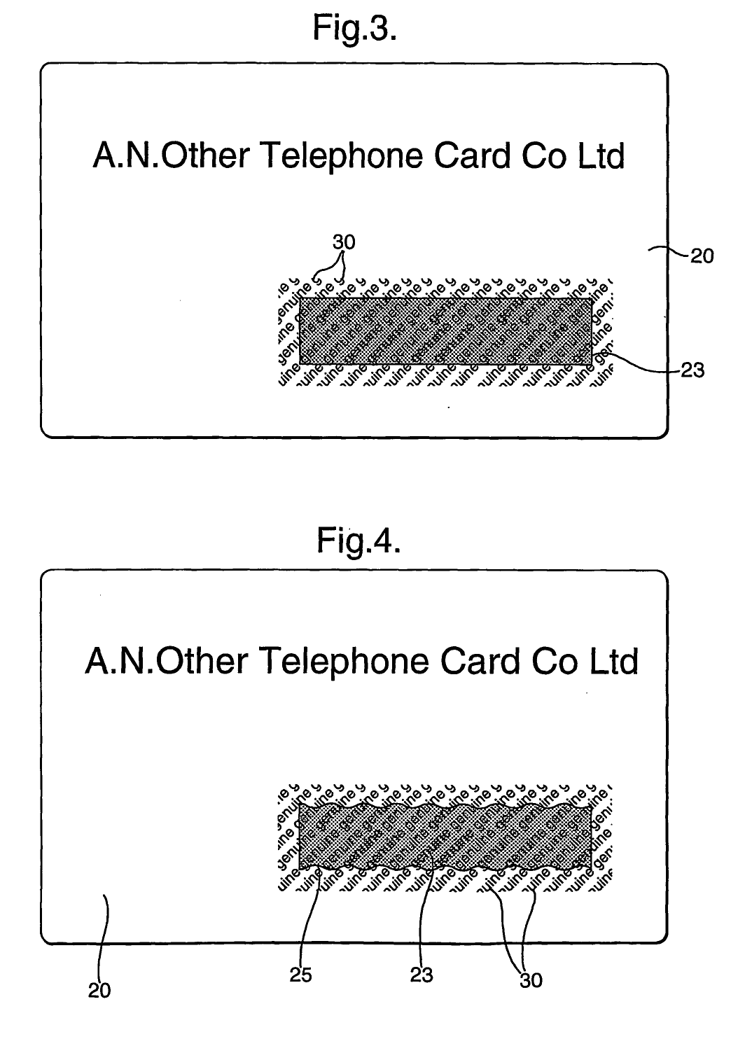

FIG. 3 is a plan view of an article carrying a scratch off pad illustrating a scratch-off device with overprinted indicia that extend onto surrounding areas of the card;

FIG. 4 illustrates a scratch-off pad 23 similar to FIG. 3 but with a scalloped edge;

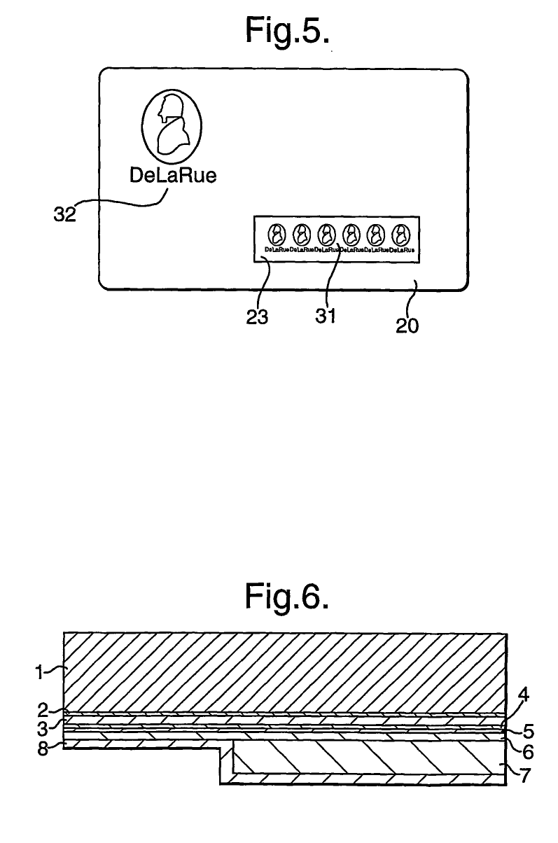

FIG. 5 illustrates the use of the same artwork in printed form on the card or document, and in holographic form on the scratch pad;

FIG. 6 is a schematic cross-section of a scratch off foil according to this invention which when deposited applies a holographic scratch off pad where the hologram overlaps onto surrounding areas of the substrate (and is not scratchable in these areas);

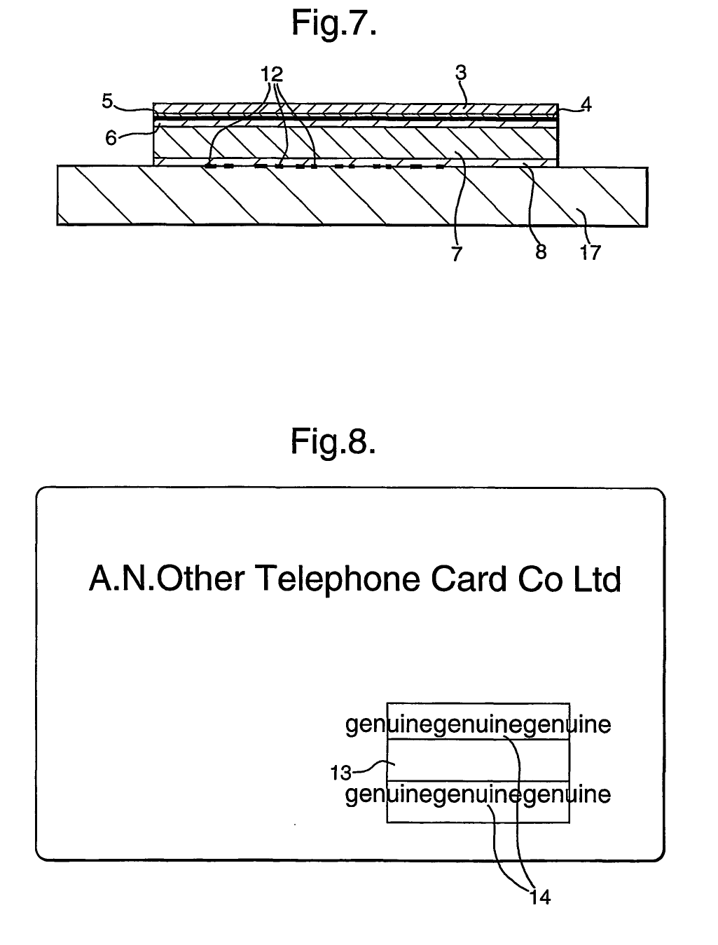

FIG. 7 shows a schematic cross-section of a scratch-off device on a substrate 17, that has been printed with secure indicia 12;

FIG. 8 illustrates a device as illustrated in FIG. 6 except that in this case the DOVID is partially transparent in the areas 14 adjacent to the pad 13, permitting printed indicia on the substrate to be read;

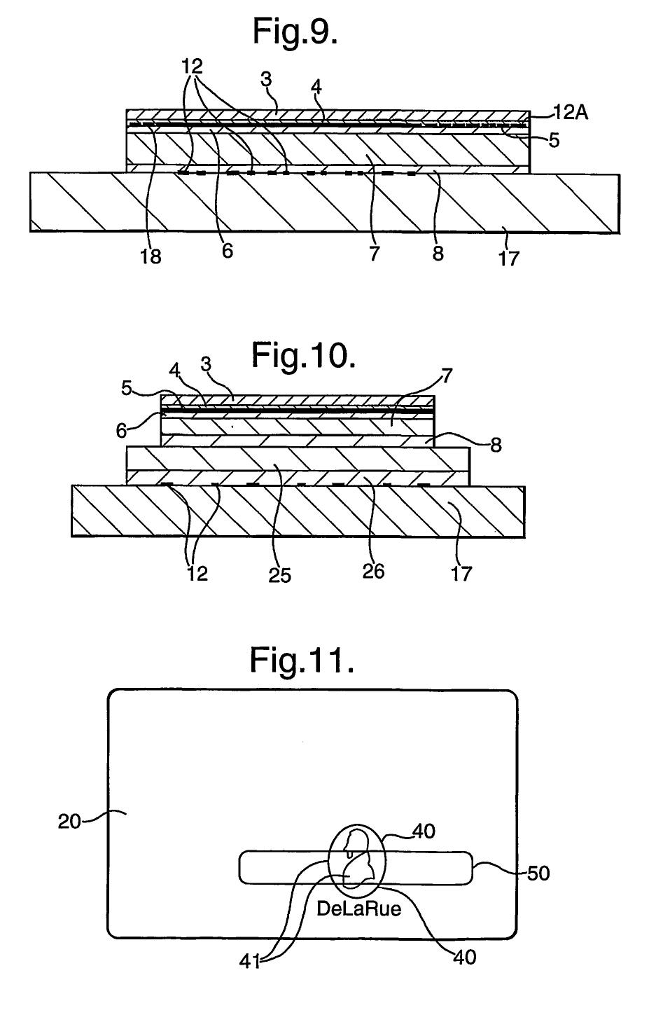

FIG. 9 illustrates a scratch-off pad in which areas of the DOVID away from the secure indicia 12 are partially transparent so as to permit viewing of the scratch-off layer itself, which may contain a variety of pigments/dyes;

FIG. 10 illustrates an example of a holographic scratch off label product;

FIGS. 11 to 13 illustrate three further examples; and,

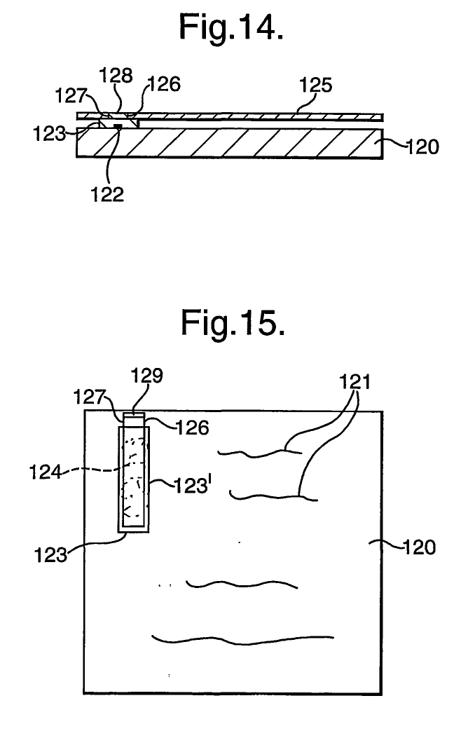

FIGS. 14 and 15 illustrate a yet further example in cross-section and plan respectively.

The background to the invention will be illustrated with reference to FIGS. 1 and 2.

The most widely used types of scratch off devices are systems that are transferred from carrier foils, and label systems. A typical transfer system is shown in FIG. 1. In this Figure, the various layers are as follows: (1) polymeric carrier foil (typically polyethyleneterepthalate (PET), (2) release layer (to facilitate transfer of the hologram from the carrier onto the final document), (3) thermoplastic embossing layer, (4) optical variability producing microstructure. (5) is an aluminium layer to enhance reflection at this interface. Most scratchable inks have difficulty adhering to coated hot-foils such as described above and hence layer (6) is an adhesion-promoting layer that adheres well to both the foil and the scratchable ink. Layer (7) is the scratchable deposit. In the preferred embodiment, the adhesive 6 is heat activatable and a range of scratchable inks are available that are suitable for this purpose, for example Sericol RR 486. Water-based scratch off inks may also be used, and these have the advantage of minimising organic solvent attack on the sensitive embossing layer and means that the material is simpler and less expensive to work with.

Many scratchable inks may be heat activated and adhere adequately to the intended substrate. There are some materials particularly those with low surface free energy surfaces such as the polyolefins that they tend not to adhere. Layer (8) is a material that will adhere to the intended substrate surface over covert information or data as well as to the scratch off layer, and hence this layer is optional and is incorporated to rectify specific adhesion problems as they arise.

FIG. 2 shows a typical device structure of a scratchable label. In this diagram items 1 to 8 are the same as in FIG. 1. (9) is a transparent filmic material such as polyethyleneterepthalate or oriented polypropylene and (10) is a transparent adhesive layer, typically a pressure sensitive adhesive, such as H.B. Fuller's SE5297.

When the label device is operated the filmic layer 9 is not disturbed, and the secure or covert data are then read through the polymer film 9 and the adhesive (10). Such devices may be counterfeited, for example, by either scraping off the scratchable material, and recoating with new, or simply removing the entire label (using techniques well known to counterfeiters, but which will not be elucidated here) and either replacing it with a counterfeit, or if it can be removed intact, simply reading the secure data and re-attaching it.

Label based scratch off devices may be used either by companies who do not have access to hot-stamping equipment or on substrates that are too rough/porous or otherwise unsuitable for scratch pads that have been transferred directly by hot-stamping/rolling, as described above. The primary reason that hot-stamped devices may not be applied to rough, porous surfaces is that when the material is scratched off pigment is retained in the pores in the surface, and this causes staining that makes the device unsightly and difficult to read. This forces manufacturers to either laminate a filmic surface over the surface and use the directly applied approach (at considerable added costs), or use the intrinsically less secure label approach.

FIG. 3 illustrates an example of the invention in which an article has a substrate 20 carrying a scratch off layer 23. The scratch off layer 23 incorporates an optically variable effect generating device of the type shown in FIGS. 1 and 2. The layer 23 is overprinted with indicia such as graphical elements or alphanumerics 30 (in this case the word “genuine”) some of which are provided on the surface of the substrate 20. These alphanumerics thus constitute a composite of first indicia on the scratch off layer 23 and second indicia on the substrate 20 (and some partly or both). If the scratch off layer 23 is removed and subsequently replaced by a counterfeit then the discontinuity in the printed elements 30 makes this easily noticeable. In the preferred embodiment the printed artwork should be of a continuous nature, extending across the scratch off layer and overlapping onto either side, so that discontinuities can be readily detected. Suitable artwork might include, for example, security printing such as guilloche designs, text and so on.

It is not possible simply to copy the printed artwork using scanning or photocopying because where it is printed over metallised areas of the optically variable effect generating device specular reflections/replay from the DOVID disrupt the process.

FIG. 4 is similar to FIG. 3 but makes it more difficult for a counterfeiter to overstamp the entire hologram by providing a scalloped edge 25 to the scratch pad 23.

FIG. 5 illustrates the use of the same artwork 32 (second indicia) in printed form on the substrate 20, and in holographic form 31 (first indicia) on the scratch pad 23.

FIG. 6 is a view similar to FIG. 1 but illustrating another example of the invention. In this case, the holographic design extends both over the scratch off pad and also across adjacent non-scratchable areas of the substrate (not shown) to which it is adhered, providing excellent resistance against type 2 counterfeits, because the hologram does not scratch off from the surrounding areas and therefore provides a direct comparison to the hologram in the scratch pad. In the case of a counterfeit the discontinuity between the DOVID on the scratch-pad and the DOVID on the surrounding areas is readily observed.

This approach may also be achieved by applying a conventional scratch pad and then over-stamping a hologram across the entire area. In FIG. 6, the scratchable ink 7 is applied discontinuously so that it only covers the scratch-pad. Layer 8 is not optional in this case and is used to transfer the device. An alternate embodiment is to apply the heat-activatable adhesive to the substrate.

FIG. 7 shows a schematic cross-section of a scratch off device similar to the device 23 of FIG. 5 on a substrate 17 that has been printed with secure or covert indicia 12.

FIG. 8 illustrates a device 13 similar to FIG. 6 except that in this case the DOVID is partially transparent in the areas 14 adjacent to the pad 13, permitting printed indicia on the substrate to be read. These areas 14 may, for example, be either partially metallised or coated with a high refractive index material. Where it overlaps directly onto the substrate, the printed matter on the card can be read through it, as shown schematically in FIG. 8. In this diagram 13 is the scratch pad, 14 are areas where the transparent hologram is applied directly to the substrate, such that the printed indicia “genuine” on the substrate can be viewed through the DOVID. This has the advantage that if a fake hologram is stamped over the entire area then the printed matter is partially obscured. If the material in question is, for example, text messages then the deception can be easily noticed, because part of the text will be obscured.

In an alternative arrangement, the partial metallisation may define the first indicia.

To achieve further authentication in this (and in the other) example a thermochromic or photochromic authentication pattern (not shown) could be printed over the covert indicia 12. After the scratch off layer has been removed, this pattern could be activated by applying suitable heat or other radiation (depending on whether the authentication ink was a thermochromic or photochromic material) allowing the viewer to authenticate the underlying indicia.

FIG. 9 illustrates a scratch off pad similar to FIG. 7 but in which areas 18 of the DOVID away from the secure or covert indicia 12 are partially transparent so as to permit viewing of the scratch off layer itself, which may contain a variety of pigments/dyes. It also includes printed (“first”) indicia 12A between layers 4 and 5 which may relate to other indica on the article.

Directly applied scratch-off devices are intrinsically more secure than label devices, but are often not suitable for porous substrates because of pigment retention problems. The pigment fulfils two essential roles: it renders the deposit opaque, and it modifies the mechanical properties of the deposit so that it will scratch properly.

In the case of holographic devices, however, the continuous metallisation can provide excellent opacity.

For example a coating of aluminium of 15-25 nm thickness has a light transmission of only 0.5-0.1%. In reflection mode, light must first pass through this layer to illuminate the secure data and light scattered from the print must then pass back through the metallisation before the observer can view it. This level of attenuation in conjunction with the scattering effect of the filler material makes it extremely difficult to discern the secure data through the deposit.

Analysis of the precise composition of the fillers by, for example using X-ray fluorescence, provides a non-destructive forensic technique for checking the authenticity of the device.

FIG. 10 illustrates an example of a holographic scratch off label product in which those components previously described have been given the same reference numbers and will not be described further. In this product, the scratch off structure is provided on a transparent destructible polymer 25 which is secured via an adhesive 26 to a final substrate 17 with secure indicia 12 printed onto the final substrate.

FIG. 11 illustrates a further example of a card having a substrate 20 on which is provided a scratchable label 50 incorporating a hologram 41 defining the “first” indicia in the form of part of a company logo. The remaining parts (“second” indicia) of the logo as indicated at 40 are printed onto the substrate 20 so as to form the whole, composite logo.

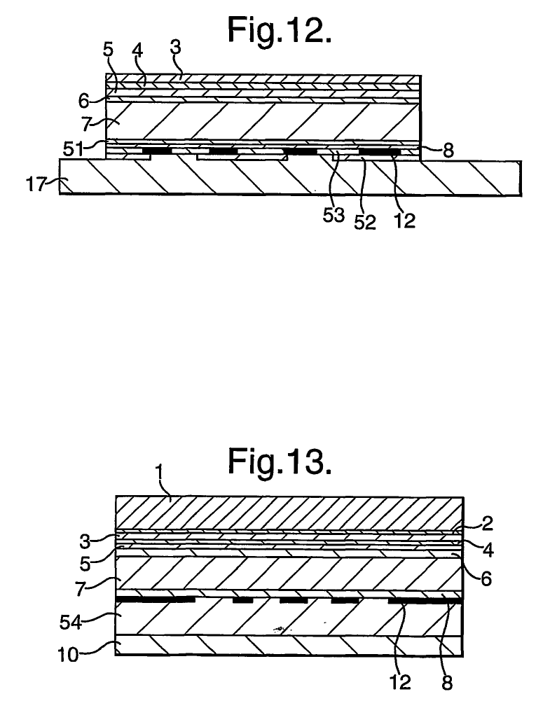

In all the examples mentioned above, the covert data has been visually readable but in addition or alternatively the data may be machine readable. An example is illustrated in FIG. 12 where, once again, the structure is similar to previous structures and so those parts which have the same form as in earlier examples-have been given the same reference numerals. In FIG. 12, in addition to the visible, secure indicia 12, a machine readable code is provided by a soft (low coercivity i.e. less than 50 Oe) magnetic layer 52 defining a series of bars of different width. Alternatively, the code may be provided by using materials with different coercivities. In order to prevent the magnetic code from being read while the scratch off device is in place, a further, hard magnetic screen or layer 51 (high coercivity i.e. greater than 100 Oe) is provided between the scratch off material 7 and adhesive layer 8. The remenance of the screen layer 51 saturates the soft magnetic material of the layer 52. As can be seen in FIG. 12, an opaque masking layer 53 is provided over the magnetic code layer 52 so as to hide the magnetic code. The indicia 12 are printed onto the masking layer.

The magnetic code 52 cannot be scratched off and is permanent once applied. The hard magnetic layer 51 is applied as a continuous layer onto which the opaque scratch off layer 7 is applied but the hard magnetic layer can also be scratched off, preferably at the same time as the opaque scratch off layer. Once the opaque scratch off layer 7 and hard magnetic layer 51 are removed, the soft magnetic code 52 can be read using known magnetic detection equipment. Although the magnetic code 52 could be used in place of the indicia 12, it is envisaged that they will be used in combination, the visual information providing public confirmation of, for example, a gaming result while the magnetic code provides a machine authentication.

In previous examples, the indicia are typically provided on a substrate 17 and a scratch off device is provided on top. FIG. 13 illustrates an approach in which both the scratch off layer and indicia can be applied to a substrate as a single transfer. This allows all the secure information to be manufactured at a single site and then distributed to authorised replicators. This allows for much greater control of the information and thus reduces fraud.

FIG. 13 is essentially a modification of the FIG. 2 example. In this modified structure, the layer 9 is replaced with a, typically opaque, polymer layer 54, which may be frangible. On this opaque layer 54, the indicia 12 such as gaming information, is printed. As a result, all the information 12 is held within one secure device. Using an ink layer rather than the PET layer 9 may further modify the device. This structure can then be transferred by hot stamping or the like onto a substrate.

In the example of the invention illustrated in FIGS. 14 and 15, a base substrate 120 of an article such as a telephone card is illustrated made of PVC or the like, typically opaque, and bearing indicia 121 (FIG. 15). The substrate 120 is also printed with secure indicia 122 which is covered by a layer of scratch off ink 123 of conventional form. In addition, the scratch off layer 123 incorporates a holographic microstructure indicated at 124. The assembly described so far may have been fabricated as a transfer device such as shown in FIG. 1 and will have been transferred onto the surface of the substrate 120 in a conventional manner.

The substrate 120 is then covered by a transparent overlaminate 125 and this overlaminate is then either die cut or perforated along lines 126,127 to define a removable portion 128. In the example, the lines 126,127 are rectilinear but they could be curved or decal edged or scalloped to provide some additional security. A small portion 129 of the section 128 has been coated on its underside with a silicone layer to define a tab.

In use, the user peels back the removable portion 128 to expose part of the scratch off layer 123. This part can then be removed to reveal the underlying number 122. It will be noted, however, that part of the scratch off layer indicated at 123′ is located laterally outside the removable portion 128 and will therefore remain intact after the portion 128 has been removed and the underlying portion of the scratch off layer 123 has been removed. This makes it very difficult indeed to reconstitute the scratch off layer and hologram without obvious discontinuities appearing.

1. A security article including a security device comprising an opaque scratch removable layer on and/or in which is provided a diffractive, optically variable effect generating structure, the scratch removable layer overlying covert information on the article, and wherein the security device exhibits first indicia which relate to second indicia elsewhere on the article.

2. An article according to claim 1, wherein the first indicia are generated by the optical variable effect generating structure.

3. An article according to claim 1, wherein the first indicia are provided, for example printed, over the optical variable effect generating structure.

4. An article according to any of claims 1 to 3, wherein the optically variable effect generating structure comprises a transparent layer defining a surface relief microstructure and a reflection enhancing layer on the surface relief.

5. An article according to claim 4, wherein the first indicia are provided between the transparent and reflection enhancing layers.

6. An article according to any of the preceding claims, wherein the optically variable effect generating structure extends onto an adjacent part of the article.

7. An article according to claim 6, when dependent on claim 4 or claim 5, wherein the reflection enhancing layer is partially transparent in the region overlying the article.

8. An article according to at least claim 4, wherein the reflection enhancing layer overlying the adjacent part of the article is a partial metallisation.

9. An article according to claim 8, wherein the partial metallisation defines the first indicia.

10. An article according to claim 9, wherein the first indicia are filled with another, differently coloured metal.

11. An article according to any of the preceding claims, wherein the first and second indicia cooperate together to define composite indicia which extend onto an adjacent part of the article.

12. An article according to any of the preceding claims, wherein the first and second indicia are the same.

13. An article according to any of claims 1 to 11, wherein the first indicia complement the second indicia.

14. An article according to any of the preceding claims, wherein the indicia comprise graphical elements or alphanumeric characters.

15. An article according to any of the preceding claims, wherein the second indicia have been printed on the article using one of flexography, offset-litho, gravure, intaglio and deskjet printing.

16. An article according to any of the preceding claims, wherein the security device has an irregular shape, such as scalloped edges.

17. An article according to any of the preceding claims, wherein the scratch removable layer comprises a coloured (apart from black or metallic) or white pigment.

18. A security device comprising an opaque scratch removable layer having an irregular shape, such as scalloped edges.

19. A security article including a security device comprising an opaque scratch removable layer on and/or in which is provided a diffractive, optically variable effect generating structure, the scratch removable layer overlying covert information on the article, and wherein the optically variable effect generating structure extends onto an adjacent part of the article beyond the scratch removable layer.

20. An article according to claim 19, wherein the optically variable effect generating structure comprises a transparent layer defining a surface relief microstructure and a reflection enhancing layer on the surface relief and wherein the reflection enhancing layer is partially transparent in the region overlying the article.

21. A security article including a security device comprising an opaque scratch removable layer on and/or in which is provided a diffractive, optically variable effect generating structure, the scratch removable layer overlying covert information on the article, and wherein the security device exhibits non-optically variable indicia within it.

22. An article according to claim 21, wherein the non-optically variable indicia are defined by an ink or pigment within the security device.

23. An article according to claim 21, wherein the optically variable effect generating structure comprises a transparent layer defining a surface relief microstructure and a reflection enhancing layer on the surface relief, the reflection enhancing layer comprising a partial metallisation defining the non-optically variable indicia.

24. A security device comprising an opaque scratch removable layer on and/or in which is provided a diffractive, optically variable effect generating structure, the scratch removable layer overlying covert information on the article in use, and a transparent overlaminate secured to the scratch removable layer over the optically variable effect generating structure, the overlaminate having a partially removable section to allow the underlying portion of the scratch removable layer to be removed but being permanently adhered elsewhere to the scratch removable layer.

25. A device according to claim 24, wherein the partially removable section of the overlaminate is die cut from the remainder of the overlaminate.

26. A device according to claim 24 or claim 25, further comprising a tab connected to the partially removable section of the overlaminate.

27. A security device comprising an opaque scratch removable layer on and/or in which is provided a diffractive, optically variable effect generating structure; and a frangible layer carrying covert information, the frangible layer being secured directly or indirectly to the scratch removable layer.

28. A device according to claim 27, further comprising an adhesive layer on the opposite side of the frangible layer to the covert information.

29. An article or device according to any of the preceding claims, further comprising a machine readable magnetic code underlying the scratch removable layer, and a magnetic screen layer overlying the machine readable magnetic code, the screen layer being removable with the scratch removable layer.

30. An article or device according to claim 29, wherein the magnetic code comprises a relatively weak magnetic material and the magnetic screen comprises a relatively strong magnetic material.

31. A security article comprising a combination of any of claims 1 to 23, 29 and 30.

32. An article according to any of claims 1 to 23 or 29 to 31, comprising one of a game card or document, lottery ticket, ticket (including travel, theatre etc.), multiple use ticket (with scratch-off areas to indicate number of times used, duration, time of commencement etc.), telephone card, personal identity number or password notification document, authenticating device on branded product or product packaging.

33. A security device comprising a combination of any of claims 24 to 30.
